(19) United States
(12) Patent Application Publication
(10) Pub. No.: US 2018/0126885 A1
(43) Pub. Date: May 10, 2018

(54) STRUCTURAL ASSEMBLY FOR A VEHICLE SEAT BACKREST

(71) Applicant: BROSE FAHRZEUGTEILE GMBH & CO. KOMMANDITGESELLSCHAFT, COBURG, Coburg (DE)

(72) Inventors: Ulf HARTMANN, Bamberg (DE); Jochen HOFMANN, Marktgraitz (DE); Thomas BITTERMANN, Coburg (DE); Andrea BAUERSACHS, Ebersdorf (DE)

(21) Appl. No.: 15/565,406

(22) PCT Filed: Apr. 15, 2016
(86) PCT No.: PCT/EP2016/058459

§ 371 Date: Jan. 29, 2018

(30) Foreign Application Priority Data
Apr. 17, 2015 (DE) 10 2015 206 962.1

(51) Int. Cl. B60N 2/68

(52) U.S. Cl. CPC B60N 2/682; B60N 2205/35; B60N 2/686

(57) ABSTRACT

It is provided a structural assembly for a vehicle seat backrest, with a surface element which is configured and designed to form at least one part of a rear wall of the vehicle seat backrest and/or to close a recess for a load through-opening in the vehicle seat backrest, and at least one interface element which is configured and designed for connecting to a further component of the vehicle seat backrest. The surface element is produced from a thermoformable composite material and is connected by a material connection to at least one part of the interface element. The at least one interface element is configured as a duct.

### CROSS-REFERENCE TO A RELATED APPLICATION

This application is a National Phase Patent Application of International Patent Application Number PCT/EP2016/058459, filed on Apr. 15, 2016, which claims priority of German Patent Application Number 10 2015 206 962.1, filed on Apr. 17, 2015.

### BACKGROUND

The present invention relates to a structural assembly for a vehicle seat backrest and a method for producing a structural assembly for a vehicle seat backrest.

Such a structural assembly comprises a surface element. The surface element is configured and provided to form at least one partial section of a rear wall of the vehicle seat backrest and/or to close a recess of a load through-opening in the vehicle seat backrest. The structural assembly further comprises at least one interface element which is configured and provided to produce a connection with a further component of the vehicle seat backrest so that the further component and the structural assembly are connected together.

The rear wall of the vehicle seat backrest generally supports a seat backrest cushion, a seat user who is seated on the vehicle seat being able to lean thereagainst. If the vehicle seat provides one or more seats in a rear seat row of a vehicle, the rear wall of the vehicle seat backrest may face a trunk of the vehicle and/or separate said trunk from a passenger compartment.

In order to be able to transport bulky goods, for example skis, which due to their length are not able to be accommodated solely in the trunk, it is known to arrange a load through-opening in the vehicle seat backrest. A load through-opening comprises a closable aperture or recess. Bulky goods such as skis may be pushed through the opened aperture or recess so that they extend on both sides of the vehicle seat backrest.

A generic structural assembly in the form of an integral load through-opening component is disclosed in DE 10 2009 040 902 A1. The load through-opening component comprises a planar surface facing the trunk as a surface element and interfaces for additional components. The planar surface provides a part of a rear wall of a vehicle seat backrest. In this case, the load through-opening component is produced in one piece from plastics material, for example in one operating step as an injection-molded component and has a low production cost with a low weight. The load through-opening component further comprises a plurality of stiffening elements, namely stiffening ribs extending diagonally to side edges of a peripheral frame of the load through-opening component.

Generally, the rear wall of a vehicle seat backrest, including an optionally provided load through-opening component, is subjected to high loads in certain situations. For example, in the case of sudden braking of the vehicle or in the case of a front collision of forces onto the vehicle seat backrest. In order to ensure the greatest possible safety of vehicle occupants who might be present in the vehicle in such situations, the vehicle seat backrest is intended to be able to withstand corresponding forces. The greatest possible stability of the vehicle seat backrest, including the optionally provided load through-opening component, is therefore desirable.

### SUMMARY

It is an object of the present invention to provide an improved structural assembly, in particular a structural assembly which has a high degree of stability with a low weight.

This object is achieved by the structural assembly having features as described herein.

Accordingly, it is provided that the surface element is produced from a thermoformable composite material and that the surface element is connected by a material connection to at least one part of the interface element. In this case, the at least one interface element is configured as a duct. The duct is configured as a weatherstrip duct and comprises at least one weatherstrip hook for securing a further component which is configured, in particular, as a covering, the duct is configured as an adhesive duct for receiving adhesive, wherein a further component is able to be bonded by means of the adhesive received in the adhesive duct, or the duct is configured as a cable duct for receiving a cable.

According to this aspect of the present invention the surface element is partially or alternatively entirely produced from a composite material, i.e. a material made of two or more materials connected together (by a material connection and/or positive-locking connection). Such composite materials have particularly good properties, depending on the actual choice of material of the components of the material composite and the nature of the composite, which influences their weight, their strength, stiffness and/or fracture toughness. The strength, stiffness and fracture toughness of a component are also denoted here as a whole as the stability. It is possible to fulfill particularly high requirements for the stability, with a particularly low weight of the structural assembly. Such requirements for the stability may, for example, have the result that the structural assembly is able to withstand the forces occurring in a vehicle crash and/or the forces occurring in the case of a potentially incorrect use of the structural assembly.

The duct may extend along surface element.

The duct, in particular in the form f a duct configured as a weatherstrip duct, is arranged, for example, in the region of the peripheral outer edge of the surface element (and/or a peripheral outer edge of the structural assembly). In particular, a plurality of weatherstrip hooks may be provided. For example a flat, flexible covering, in particular a material, plastics or leather web may be connected to the weatherstrip duct.

If the duct is configured as an adhesive duct for receiving adhesive, a further component (for example the flat, flexible covering, in particular a material, plastics or leather web) is able to be bonded to the adhesive duct by means of the adhesive received in the adhesive duct.

If the duct is configured as a cable duct for receiving a cable, a cable may be held by non-positive locking in the cable duct. At least one chicane may be provided in the cable duct, for example for strain relief.

Naturally, in addition to the at least one interface element configured as a duct, the structural assembly may comprise further interface elements, for example one or more further interface elements configured as a duct.

Preferably, the thermoformable composite material of the surface element is configured as a fiber composite material in which fibers are embedded in a matrix. By way of example, the fiber diameters are in a range of a few μm or a few dozen μm, wherein materials having diameters which deviate markedly therefrom may also be suitable. Suitable as fiber materials, amongst others, are glass fibers, carbon fibers, ceramic fibers, aramid fibers, steel fibers, fabric fibers, nylon fibers and any mixtures thereof and/or other fiber materials. The fiber material may be present in the form of endless fibers. Moreover, it may be provided that the composite material is configured as a composite consisting of a plastics matrix, in particular a matrix consisting of a thermoplastic (for example polypropylene and/or polyamide) and a fiber material embedded therein. The fiber material may be configured in the form of a fiber material part. The fiber material part is, for example, fully enclosed by the plastics matrix. An advantage of the use of a thermoplastic matrix is that such a composite material is thermoformable (heat formable), in contrast for example to thermosetting plastic fiber composite materials. When injection-molding with plastics material a thermoplastic may additionally be fused thereon, whereby a material connection is produced with the injection-molded plastics material. Preferably, an organosheet is used as the composite material.

According to a development, the fiber material part is configured in the form of a woven or nonwoven fabric consisting of fibers. It is also possible to configure the fiber material part in the form of a balanced woven fabric. In this case more and/or stronger fibers in the form of warp fibers may be provided than fibers in the form of weft fibers (or vice versa). Alternatively or additionally, the fiber material part may be configured as a sheared woven fabric. In a sheared woven fabric the warp fibers and the weft fibers enclose between one another an angle of 40° to 50°, in particular 45° (relative to a longitudinal direction of extension of the warp/weft fibers). It is also possible to arrange fibers in parallel or in a chaotic manner. It may also be provided to configure a first region of the fiber material part in a first of the aforementioned ways and to configure a second region of the fiber material part in a second of the aforementioned ways which differs from the first. Thus the stability of the structural assembly may be adapted to predetermined requirements for load-bearing capacity.

Moreover, a plurality of different composite materials may also be used in order to form the surface element entirely or partially.

It may be provided that the fiber material part of the surface element is not fully consolidated in a partial region. In particular, an incomplete consolidation may be provided in a region of the material connection to the interface element. “Not fully consolidated” means that the fibers of the fiber material part in one region are present with a lower density than in a different region and/or with a density which is lower than a nominal density of the composite material. In this manner, the stability of the connection between the surface element and the interface element may be increased.

Moreover, the fiber material part may have at least one cutout. Thus, for example, an increased flexibility of an adjacent region of the surface element may be achieved.

The interface element may be produced from a different material from the surface element. The use of other materials for the interface element relative to the surface element has the advantage that correspondingly adapted different materials are respectively used for different tasks of the components. The surface element in this case is produced by a particularly stable material whilst a more cost-effective material may be used for the interface element, for example. Alternatively, the interface element is produced from the same material as the surface element.

The surface element is preferably configured (at least in a cross section) to be trough-shaped. For example, a peripheral edge of the surface element is at least partially bent back to form a trough shape. Between the bent-back edges, the trough element may be configured to be at least partially planar. By means of the trough shape, the stability of the surface element may be increased relative to an entirely planar design. Alternatively, it may be provided that the entire surface element extends in a planar surface.

The surface element may form a receiver. The receiver may provide at least one part of a rotary joint bearing for attaching the structural assembly to the vehicle seat backrest. The receiver is configured, for example, as an elongated depression. As a result, a particularly stable mounting of the structural assembly on the vehicle seat backrest may be achieved.

An edge of the surface element, in particular a peripheral outer edge, may have at least partially a C-shaped or Z-shaped cross section. Su h a cross section may improve the stability of the surface element.

The surface element and/or the interface element may comprise at least one set rupture point. As a result, a predetermined behavior of the structural assembly may be achieved, for example in the event of a vehicle crash.

The at least one interface element is arranged according to one embodiment in the region of the edge of the surface element, in particular in a region of the edge which has a C-shaped or Z-shaped cross section. The interface element may be arranged in the region of an inner edge or outer edge formed by a C-shaped or Z-shaped cross section of the edge of the surface element. Alternatively or additionally, one or more interface elements differing from the at least one interface element are correspondingly arranged in the region of the edge of the surface element, particular in a region of the edge which has a C-shaped or Z-shaped cross section.

At least one further interface element may be provided. and, for example, comprise a screw dome. The further component of the vehicle seat backrest is able to be screwed to the screw dome.

Alternatively or additionally to a receiver configured in the surface element providing at least one part of a rotary joint bearing, at least one further interface element may be provided and provide a rotary joint bearing. The rotary joint bearing serves for the pivotable attachment of the structural assembly to the vehicle seat backrest or for the pivotable attachment of an armrest to the structural assembly.

The rotary joint bearing may be configured with an undercut. Thus, for example, a pivot (for example a transverse tube) may be clipped into the rotary joint bearing for pre-fixing. As a result, a mounting of the structural assembly to the vehicle seat backrest is facilitated.

The interface element, in particular the at least one further interface element, may be connected to an insert part. The insert part may represent a part of the interface element. The insert part is preferably, connected by positive locking to the surface element. The insert part is, in particular, produced from a metal and thus optionally particularly load-bearing. In this case an outer portion of the interface element at least partially surrounds the insert part and is connected to the surface element by a material connection. The outer portion effects the connection by positive locking of the insert part to the surface element. In this manner, a secure and load-bearing connection of the insert part to the surface element may be achieved.

According to a development, the insert part comprises at least one opening an/or recess, a partial region of the surface element being pressed therein. In this manner, a particularly stable connection by positive locking may be formed in the manner of a clinch connection.

In a development, the at least one further interface element is configured such that it is able to be connected to a headrest. In this case, the insert part may be configured as a headrest bracket. The headrest bracket comprises one or more, in particular two, receivers which are configured in each case to receive and support a headrest rod of the headrest. Alternatively, the insert part itself forms the headrest rod.

In a development, at least one insert part of an interface element is configured as a threaded insert. The threaded insert may be arranged at least partially inside an opening of the surface element. The further component is able to be screwed to the threaded insert. The threaded insert comprises an external thread and/or an internal thread. According to one variant, the threaded insert comprises a widened foot. In this case, the surface element is arranged between the widened foot of the threaded insert and the further component connected to the threaded insert. The widened foot of the threaded insert has a greater diameter than the assigned opening in the surface element. The opening in the surface element is configured, for example, as a conical passage. The opening may be configured such that the fibers of a fiber material part of the surface element do not terminate in the region of the opening. The fibers may be guided around the opening (displaced out of the region of the opening).

At least one interface element may be configured and designed for connecting to an actuating element. The actuating element is, for example, able to be actuated for locking and/or unlocking a lock. In this case it is, in particular, a lock which in a locked state locks the structural assembly to the vehicle seat backrest and in an unlocked state permits a pivoting of the structural assembly relative to the vehicle seat backrest. The interface element may comprise at least one guide track which is designed and configured to guide the actuating element during the actuation thereof.

In one variant, at least one further interface element is configured as a top tether strap. The top tether strap permits a connection to a seat belt guided over the vehicle seat backrest. The top tether strap may be produced from a thermoformable composite material, in particular the same thermoformable composite material as the surface element. The top tether strap may be configured by a cutout of the surface element.

In one variant, at least one further interface element has a resilient spring element. The spring element is configured and designed to cushion an adjacent further component of the vehicle seat backrest during a relative movement between the structural assembly and the adjacent further component of the vehicle seat backrest.

According to a development, the structural assembly comprises at least one stiffening element which is configured and designed for increasing the stiffness of the surface element.

The surface element produced from a thermoformable composite material is in one variant connected by a material connection to at least one part of the stiffening element. In this manner, a particularly high degree of stability of the structural assembly may be achieved.

If the composite material is configured as a composite of a thermoplastic matrix and a fiber material part embedded therein, in particular as an organosheet, it may be provided that the fiber material part of the surface element is not fully consolidated in a region of the material connection with the stiffening element. In this manner, the stability of the connection may be increased between the surface element and the interface element.

The stiffening element may be produced from a different material from the surface element. The use of other materials for the stiffening element relative to the surface element has the advantage that different materials are used in each case for different tasks, correspondingly adapted to the components. The surface element in this case is produced by a particularly stable material whilst a more cost-effective material may be used for the stiffening element, for example. Alternatively, the stiffening element is produced from the same material as the surface element.

For example, the stiffening element and/or interface element is not produced from a composite material. It may be provided that the at least one stiffening element and/or interface element comprises a plastics material, in particular consists entirely of this plastics material. In this case polyolefins and namely, in particular, polypropylene are suitable as materials. However, also the use of Plexiglas, polycarbonate, polystyrene and/or polyamide and also the use of an elastomer and/or a thermosetting plastic is possible.

In particular, the stiffening and/or interface element may be produced from the same material as the thermoplastic matrix of the composite material of the surface element.

According to one variant, the stiffening element has at least one set rupture point. As a result, for example in the event of a vehicle crash, a predetermined behavior of the structural assembly may be achieved.

At least one stiffening element may comprise an insert part. The insert part of the stiffening element may, be connected by positive locking to the surface element and, in particular, may be produced from a metal.

The structural assembly forms with the surface element and the at least one interface element, and optionally the at least one stiffening element, a structural unit which is able to be pretested and which is able to be mounted on a vehicle seat, in particular on the backrest of the vehicle seat. The structural assembly is preferably designed integrally. A seat cushion, covering parts and/or further components may be connected to this mounted structural assembly.

By the material connection of the surface element to the interface element and optionally to the at least one stiffening element a particularly stable connection of the components is achieved. A material connection may be produced by injection-molding the surface element with a plastics material. By a material connection thus produced, the at least one injection-molded stiffening element and/or interface element does not have to be fastened in a costly manner to the support part.

The stiffening element is configured, for example, as an elongated stiffening rib. The stiffening rib extends along the surface element and protrudes therefrom. The structural assembly comprises, in particular, a plurality of stiffening ribs.

At least one stiffening rib may at least partially have a linear path along the surface element. The stiffening rib extends, for example, in a plane which extends vertically relative to at least one part of the surface element. Alternatively or additionally, the stiffening rib (at least partially) protrudes at an angle from the surface element.

In a development, at least one support rib is provided which protrudes vertically from the (in particular linear) path of the stiffening rib and along the surface element. The support rib may, in particular, comprise an open end. The support rib forms with an adjacent portion of the stiffening rib the shape of a T.

The stiffening rib and/or the support rib may be configured to be S-shaped, C-shaped, L-shaped or T-shaped in cross section. In particular, by such cross-sectional shapes an enlarged contact surface may be achieved between the stiffening rib and the surface element. An enlarged contact surface may improve the stability of the connection. Alternatively or additionally, the stiffening rib may be designed to be convex (curved). As a result, a direction of the buckling of the stiffening rib under load may be predetermined.

According to a further aspect of the present invention, a structural assembly for a vehicle seat backrest is provided which has a surface element which is configured and designed to form at least one part of a rear wall of the vehicle seat backrest and/or to close a recess for a load through-opening in the vehicle seat backrest, and at least one stiffening element which is configured and designed to increase the stiffness of the surface element and/or at least one interface element which is configured and designed for connecting to a further component of the vehicle seat backrest. In this case, it is provided that the surface element is produced from a thermoformable composite material and is connected by a material connection to at least one part of the stiffening element and/or the interface element, wherein the at least one interface element is configured and designed for connecting to an actuating element which is able to be actuated for locking and/or unlocking a lock, wherein the interface element comprises at least one guide track which is designed and configured to guide the actuating element during an actuation.

As a result, a particularly secure retention of the actuating element may be achieved.

The lock is, in particular, a lock which in a locked state locks the structural assembly to the vehicle seat backrest and in an unlocked state permits a pivoting of the structural assembly relative to the vehicle seat backrest.

With regard to possible embodiments, in particular of the surface element, the at least one stiffening element and the at least one interface element, as well as the connection thereof together, reference is made to the embodiments relative to the first-mentioned aspect of the present invention.

According to a further aspect of the present invention, a vehicle seat for a motor vehicle which comprises a backrest with a structural assembly according to any embodiment described herein is provided.

According to a further aspect of the present invention, a method for producing a structural assembly for a vehicle seat backrest is provided. The method comprises the following steps:
providing a surface element which is configured and designed to form at least one part of a rear wall of the vehicle seat backrest and/or to close a recess of a load through-opening in the vehicle seat backrest and
to provide at least one interface element which is configured and designed for connecting to a further component of the structural assembly.

In this case it is provided that:
the surface element is produced from a thermoformable composite material and
the surface element is connected by a material connection to at least one part of the interface element,
   wherein the at least one interface element is configured as a duct, which
is configured as a weatherstrip duct and comprises at least one weatherstrip hook for securing a covering as a further component,
is configured as an adhesive duct for receiving adhesive, wherein a further component is able to be bonded by means of the adhesive received in the adhesive duct, or
is configured as a cable duct for receiving a cable.

In this case, depending on the choice of the materials actually used, a particularly lightweight and stable structural assembly may be produced. In particular, relative to the choice and design of the materials actually used in the method and the corresponding advantages, reference is made to the above description relative to the materials of the structural assembly.

In order to produce a material connection between the at least one interface element and the surface element, in principle several possibilities exist, such as for example bonding or welding the components or the like. In particular, the interface element may be injection-molded by means of injection-molding to the surface element. During the injection-molding, for example, the same material may be used as the material of a thermoplastic matrix of the surface element.

In a development, a two component injection-molding process is used. A component of the two component injection-molding may be an elastomer, for example resilient elements for tolerance compensation. The same material may be used for a further component as for a thermoplastic matrix of the surface element.

During the injection-molding, at least one insert part (insert) may be encapsulated by injection-molding. The insert part is preferably produced from metal (for example steel). Alternatively, the insert part may be produced from an elastomer, from a plastics material (for example the same plastics material which is also used for the thermoplastic matrix of the surface element) or from a thermoformable composite material (in particular organosheet).

When shaping the composite material, a portion of the composite material may be pressed into an opening or recess of an insert part, for example by means of a mandrel configured accordingly. An encapsulation by injection-molding or overmolding of the insert part may take place subsequent to the shaping. As a result, it is possible to produce a particularly stable positive-locking and material connection of the insert part to the surface element in the manner of a clinch connection.

The composite material may be configured as a composite of a thermoplastic matrix and a fiber material part embedded therein. In this case, at least one opening may be configured in the surface element. For forming the opening, the fibers of the fiber material part may be displaced substantially without damage. In this manner, it is possible to configure an opening in the surface element passing through the fiber material part, without substantially impairing the stability of the surface element.

In a development of the method, at least one stiffening element which is configured and designed to increase the stiffness of the surface element (10) is provided.

The surface element produced from a thermoformable composite material is in one variant connected by, in particular, a material connection to at least one part of the stiffening element.

According to one variant, the stiffening element is injection-molded by means of injection-molding to the surface element, in particular by means of a two component injection-molding method.

With regard to the connection of the at least one stiffening element to the surface element, reference is made to the above embodiments relative to the connection of the at least one interface element to the surface element which apply correspondingly to the stiffening element.

The stiffening element and/or the interface element may be injection-molded onto the surface element such that at the transition between the stiffening element/interface element and the surface element a sharp edge is produced (for example an edge with an acute angle). The stiffening element and/or the interface element may be configured, in particular, to this end with a chamfer adjoining the surface element or a shoulder adjoining the surface element. By means of a sharp edge, a particularly clean sealing may be achieved of the tool of an injection-molding tool.

In a development of the method, during the injection-molding of the stiffening element and/or interface element onto the surface element, a surface of the surface element brought into contact thereby is heated and fused thereto. Such fusing assists the construction of a material connection.

A simplification of the production method of the structural assembly may be achieved if both the shaping of the composite material and the injection-molding of the at least one stiffening and/or interface element onto the surface element takes place in the same (injection-molding) tool, in particular in a one-shot process. In this case, the composite material may be heated before insertion into the injection-molding tool and/or in the injection-molding tool. The shaping may take place by the injection-molding tool and/or by the action of the injection-molded mass.

The composite material may be cut to size in a desired shape in order to shape the surface element from this material pre-cut part (and optionally additionally components to be connected thereto). The cutting to size may take place, but does not necessarily have to, before the connection to the at least one stiffening element and/or the interface element.

During the production of the surface element the thermoformable composite material may be shaped by means of thermoforming.

According to a further aspect of the present invention a method for producing a structural assembly for a vehicle seat backrest is provided. The method comprises the following steps:
providing a surface element which is configured and designed to form at least one part of a rear wall of the vehicle seat backrest and/or to close a recess of a load through-opening in the vehicle seat backrest, and
to provide at least one stiffening element which is configured and designed for increasing the stiffness of the surface element and/or at least one interface element which is configured and designed for connecting to a further component of the structural assembly.

In this case it is provided that:
the surface element is produced from a thermoformable composite material and
the surface element is connected by a material connection to at least one part of the stiffening element and/or the interface element,
   wherein the at least one interface element is configured and designed for connecting to an actuating element which may be actuated for locking and/or unlocking a lock, wherein the interface element comprises at least one guide track which is designed and configured for guiding the actuating element during an actuation.

In this case, depending on the choice of the materials actually used, a particularly lightweight and stable structural assembly may be produced. In particular relative to the choice and design of the materials actually used in the method and the corresponding advantages, reference is made to the above description relative to the materials of the structural assembly.

A structural assembly according to the invention is also able to be produced by a method according to the invention for producing a structural assembly. The features and advantages of a method according to the invention described above and shown hereinafter for producing a structural assembly also apply to a structural assembly according to the invention and vice versa.

### BRIEF DESCRIPTION OF THE DRAWINGS

Further advantages and features of the present invention are revealed from the following description with reference to the figures.

FIG. 1 shows an exemplary embodiment of a structural assembly according to the invention with a plurality of stiffening elements and a plurality of interface elements in a perspective view.

FIG. 2 shows a plan view of a front face of the structural assembly according to FIG. 1.

FIG. 3 shows a plan view of a rear face of the structural assembly according to FIGS. 1 and 2 as well as an enlarged detail of the plan view.

FIG. 4 shows a sectional view of the structural assembly according to the cutting plane A-A shown in FIG. 2.

FIG. 5 shows an enlarged detail of the view according to FIG. 4.

FIG. 6 shows a sectional view of the structural assembly according to the cutting plane B-B shown in FIG. 1.

FIG shows a view of the plane C-C shown in FIG. 2 of a lower portion of the structural assembly.

FIG. 8 shows a view of the plane D-D shown in FIG. 2 of a lower portion of the structural assembly with a support arm of the vehicle seat backrest connected thereto.

FIG. 9 shows a sectional view of the structural assembly according to the cutting plane E-E shown in FIG. 2.

FIG. 10 shows a sectional view of the structural assembly according to the cutting plane F-F shown in FIG. 1.

FIG. 11 shows a plan view of an outer face of a lock of the structural assembly according to FIGS. 1 to 10.

FIG. 12 shows a plan view of an inner face of the lock according to FIG. 11.

FIG. 13 shows a sectional view of the lock according to the cutting plane G-G shown in. FIG. 12.

FIG. 14 shows a side view of the structural assembly according to FIGS. 1 to 13.

FIG. 15 shows an exemplary embodiment of an insert part connected to a surface element of a structural assembly.

FIG. 16 shows a further exemplary embodiment of an insert part connected to a surface element of a structural assembly.

FIG. 17 shows a further exemplary embodiment of an insert part connected to a surface element of a structural assembly.

FIG. 18 shows a cross section of a connecting region of a stiffening element with a surface element of a structural assembly.

FIG. 19 shows a plan view of a rear face of a structural assembly.

### DETAILED DESCRIPTION

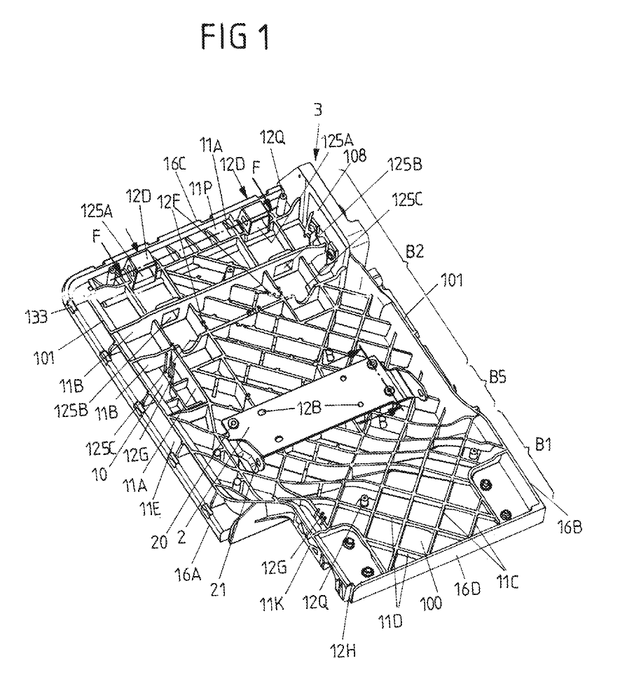

FIGS. 1 to 3 illustrate the general construction of a structural assembly 1 for a vehicle seat backrest of a seat arrangement of a vehicle. The structural assembly 1 comprises a planar and flat surface element 10. In a manner described in more detail hereinafter, a plurality of stiffening elements 11A-11P are connected by a material connection to the surface element 10. These stiffening elements increase in each case the stiffness of the surface element 10, for example relative to distortion, twisting and/or relative to rupture of the surface element 10 when under load. Moreover, a plurality of interface elements 12A-12R are connected by a material connection to the surface element 10. These interface elements serve in each case for connecting the structural assembly 1 to a further component of the seat arrangement.

The structural assembly 1 is configured in the form of a load through-opening device which, for example, is able to be arranged on the backrest of a rear seat arrangement of the vehicle. The backrest of the rear seat arrangement separates a trunk from a passenger compartment of the vehicle and comprises a (load through-opening) recess. For example, bulky loads may be transported extended through the recess. The recess may also permit access to loads accommodated in the trunk from the passenger compartment. The structural assembly 1 is provided to close the recess in a closed state and, if required, is able to be transferred into an open state in which it at least partially opens up the recess.

If the structural assembly 1 is in the closed state it provides a part of the backrest. A seat user may lean against the structural assembly 1. To this end, the structural assembly 1 is provided with a cushion, not shown in the figures.

The structural assembly 1 is connected to a plurality of further components of the vehicle seat backrest. In the present case, an armrest support 2 and a lock 3 are fastened to the structural assembly 1. Moreover, the structural assembly 1 is able to be connected to further components, not shown in FIGS. 1 to 3, namely in particular to a plurality of covering parts, a transverse tube for attaching the structural assembly 1 to the vehicle seat backrest, a headrest and cables.

The structural assembly 1 has two outer side edges 16A, 16B, namely a left-hand side edge 16A in the view of the front face of the structural assembly 1 shown in FIG. 1 and an opposing right-hand side edge 16B.

The side edges 16A, 16B adjoin adjacent regions of the backrest when the structural assembly 1 closes the recess of the backrest as intended. Moreover, the structural assembly 1 has an upper end edge 16C and a lower end edge 16D which together with the side edges 16A, 16B in the plan view of the front face substantially describe the shape of a rectangle. The side edges 16A, 16B are longer than the upper and lower end edges 16C, 16D. The structural assembly 1 is configured such that the upper end edge 16C terminates substantially flush with the adjacent upper end edges of adjoining regions of the backrest when the structural assembly 1 closes the recess of the backrest as intended. The lower end edge 16D adjoins a seat surface of the seat arrangement.

The structural assembly 1 tapers in a region B1 adjoining the lower end edge 16D, so that the lower end edge 16D is shorter than the upper end edge 16C. The tapered region B1 is set back (in a stepped manner) relative to a non-tapered region B2 and namely in the direction of a seat user seated on the seat arrangement.

The surface element 10 extends substantially over the entire surface between the side edges 16A, 16B and the upper and lower end edges 16C, 16D. The surface element is produced from a material composite of a thermoplastic matrix with a fiber material part embedded therein and namely in practice from organosheet.

The stiffening elements 11A-11P and the interface elements 12A-12R are not produced from organosheet. The stiffening elements 11A-11P and the interface elements 12A-12R are produced from a thermoplastic material. In the present case the thermoplastic material of the stiffening and interface elements 11A-11P, 12A-12R is the same material as in the thermoplastic matrix of the surface element 10, for example polypropylene. The stiffening elements 11A-11P and the interface elements 12A-12R are (at least partially) injection-molded by means of injection-molding onto the surface element 10. The surface element 10 is thus designed integrally but from different materials.

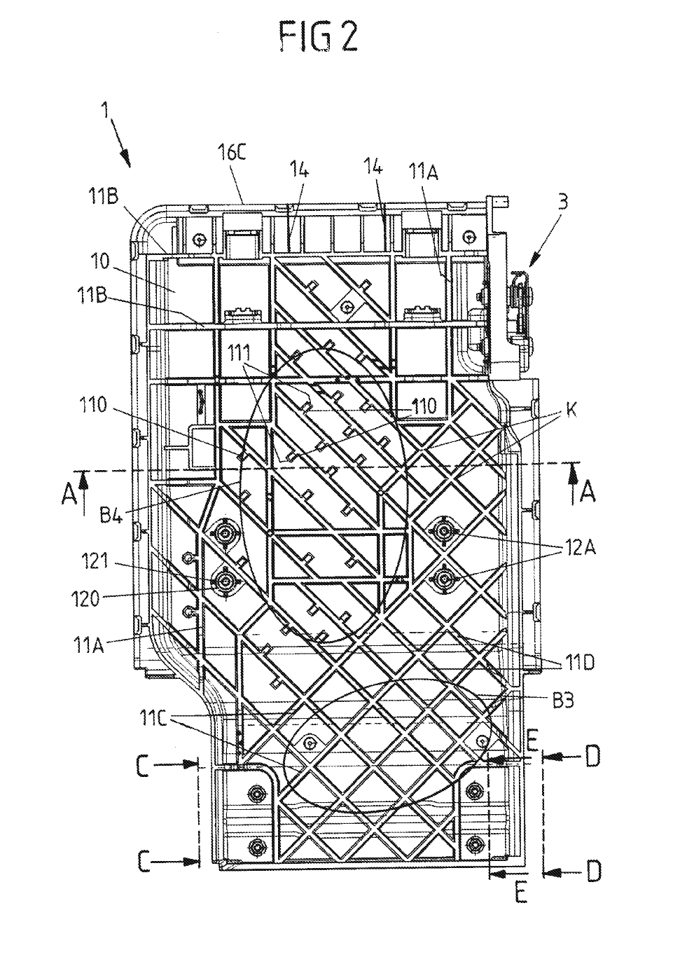

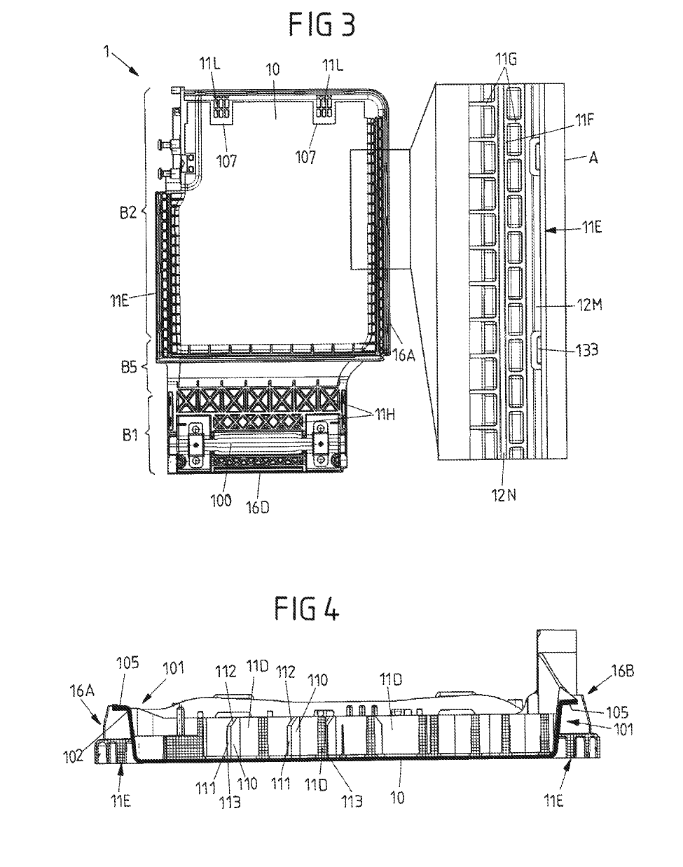

The structural assembly 1 comprises a plurality of stiffening elements in the form of stiffening ribs 11A-11D, 11F-11H, 11N. In this case stiffening ribs are arranged both on the front face, which is visible in FIGS. 1 and 2, and on the rear face of the structural assembly 1 shown in FIG. 3. If the structural assembly closes the recess of the backrest of the seat arrangement as intended, the front face of the structural assembly 1 faces a seat user seated on the seat arrangement. The rear face of the structural assembly 1 thus faces the trunk of the vehicle. The rear face of the structural assembly is thus configured to be substantially planar, in particular in the tapered region B1 and in the non-tapered region B2. In the non-tapered region B2, on the rear face of the structural assembly 1 stiffening elements 11E-11G, 11L are provided only in the edge regions.

All of the stiffening ribs 11A-11D arranged on the front face of the structural assembly 1 extend substantially over the entire height and width of the surface element 10, as in particular may be identified from FIG. 2. The stiffening ribs 11A-11D in this case protrude from the surface element 10. The stiffening ribs 11A-11D describe at least partially a linear shape. In this case a plurality of vertical stiffening ribs 11A which extend parallel to the side edges 16A, 16B are provided. Moreover, a plurality of horizontal stiffening ribs 11B which extend parallel to the upper and the lower end edge 16C, 16D (and vertically relative to the vertical stiffening ribs 11A) are provided. The structural assembly 1 also comprises a plurality of stiffening ribs 11C which are inclined to the right, which are inclined substantially by 45° relative to the vertical and horizontal stiffening ribs 16A, 16B (in the view according to FIG. 2 to the right relative to the vertical stiffening ribs 11A). Moreover, a plurality of stiffening ribs 11D which are inclined to the left are provided, said stiffening ribs extending vertically relative to the stiffening ribs 11C inclined to the right.

A plurality of stiffening ribs 11A-11D are in each case aligned parallel with one another. Differently aligned stiffening ribs 11A-11D intersect one another in a plurality of intersection points K.

In the present case the stiffening ribs 11A-11D are arranged on the front face of the structural assembly 1 such that an intersection region B3 is produced, in which a plurality of stiffening ribs 11C inclined to the right and a plurality of stiffening ribs 11D inclined to the left are arranged in the form of a lattice and form a plurality of intersection points K. The intersection region B3 is arranged adjacent to the lower end edge 16D. A large proportion of the intersection region B3 extends in the tapered region B1 of the structural assembly 1. In the tapered region B1 the stiffening ribs 11C, 11D may be subjected to a compressive load when using the structural assembly 1 in the vehicle seat backrest. The compressive load may, in particular in the case of a rear crash of the vehicle, be exerted by a seat user leaning against the structural assembly 1.

In particular in the case of a rear crash of the vehicle, a force may be exerted by a seat user on the front face of the structural assembly 1. Such a force may lead, in particular, to a deformation of the surface element 10. With such a deformation, the stiffening ribs 11D arranged on the front face of the structural assembly 1 in a central and/or upper region of the surface element 10 are extended along their longitudinal extent (subjected to a tensile load). In this region, the stiffening ribs 11D are configured to be substantially parallel and without intersection points (or with only a few intersection points per surface unit in comparison with the intersection region B3) and form a parallel region B4.

A plurality of support ribs 110 is arranged in the parallel region B4. The support ribs 110 in each case are integrally connected to a stiffening rib 11D inclined to the left. The support ribs 110 protrude substantially vertically from the connected stiffening rib 11D and have an open end 111 at their portion remote from the stiffening rib 11D. The open end 111 is not connected to a stiffening rib 11A-11D. The support ribs 110, viewed along the surface element 10, are shorter than the distance between the connected stiffening rib 11D and the next adjacent parallel stiffening rib 11D.

The parallel region B4 in the intended use of the structural assembly 1 in the closed state thereof is arranged above the intersection region B3. An (imaginary) diagonal line between the lock 3 and a left-hand lower corner of the structural assembly 1 (between the left-hand side edge 16A and the lower end edge 16D) describes an upper triangle and a lower triangle of the structural assembly 1. The parallel region B4 is substantially arranged inside the upper triangle. The intersection region B3 is arranged substantially inside the lower triangle.

The structural assembly 1 is, in particular, stiffened by the parallel region B4 relative to distortion in the region of a left-hand upper corner of the structural assembly 1 (between the left-hand side edge 16A and the upper end edge 16C). The support ribs 110 prevent a lateral kinking of the stiffening ribs 11D.

Alternatively or additionally, support ribs 110 may also be provided on stiffening ribs 11A-11C which are vertical, horizontal and/or inclined to the right.

In the tapered region B1 and in the non-tapered region B2 the surface element 10 is substantially planar and has edges 101 bent back toward the front face. The planar portions of both regions B1 and B2 are aligned parallel to one another. The tapered region B1 and the non-tapered region B2 transition into one another in a step-like transition region B5. As may be identified in particular by observing FIGS. 1 and 2 together, the stiffening ribs 11A-11D in the tapered and non-tapered region B1, B2 protrude substantially vertically from the surface element 10. In the transition region B5, the stiffening ribs 11A-11D protrude from the surface element 10 such they extend in planes which are aligned vertically relative to the planar regions of the surface element 10 in the tapered and in the non-tapered region B1, B2. Both in the planar and in the non-planar regions of the surface element 10 the stiffening ribs 11A-11D extend vertically relative to the planar regions of the surface element 1.

The edge 101 of the surface element 10 is provided with a stiffening element in the form of an edge reinforcement 11E, 11K. The edge reinforcement 11E is produced from the same material as the stiffening ribs 11A-11D, 11F-11H, 11N.

On the rear face of the surface element 10 (see FIG. 3) stiffening elements in the form of stiffening ribs 11H are provided in the tapered region B1 of the structural assembly 1. In this case a plurality of intersections are provided which are formed by two respective stiffening ribs 11H, and the intersection is framed by further stiffening ribs 11H. A plurality of such framed intersections are arranged in a row. Further intersecting stiffening ribs are arranged adjacent to the row of framed intersections of stiffening ribs 11H, wherein a plurality of intersections are framed together by further stiffening ribs 11H. Adjacent to the lower end edge 16D, a plurality of stiffening ribs 11H are arranged along the lower end edge 16D such that they form a zig-zag shape.

On the rear face of the surface element 10 further stiffening elements are provided on non-planar regions of the surface element 10. On the side edges 16A, 16B of the structural assembly 1 the surface element 10 is bent back in the direction of its front face. In FIG. 3 a detail A of a part of the side edge 16A of the structural assembly 1 is shown enlarged. In this region the edge reinforcement 11E is provided with a plurality of longitudinal ribs 11F. The longitudinal ribs 11F extend parallel to the side edges 16A, 16B. A plurality of connecting ribs 11G extend vertically relative to the longitudinal ribs 11F. The connecting ribs 11G are arranged in a plurality of rows (in the present case two per side edge 16A, 16B). In this case the connecting ribs 11G of one row are arranged offset relative to the connecting ribs 11G of an adjacent row.

In a similar manner, parts of the rear face of the transition region B5 on which the surface element 10 is bent back are also provided with reinforcing elements. Here only one row of connecting ribs 11G is provided.

FIG. 4 shows a sectional view of the structural assembly 1. It may be identified therein that the edges 101 of the surface element 10 are bent back at the side edges 16A, 16B of the structural assembly 1 toward the front face. Between the edges 101 the surface element 10 is substantially planar. The edges 101 comprise one respectively outwardly oriented flange 105 which is arranged substantially parallel to the planar portion of the surface element 10 between the edges 101. The edges 101 of the surface element are thus configured to be approximately Z/S-shaped. The flange 105 forms with the remaining edge 101 of the surface element 10 an inner edge 102.

In cross section the surface element 10 substantially has a trough shape. By the described design of the edges 101 of the surface element 10 a particularly high degree of stability of the structural assembly 1 may be achieved.

The edge 101 of the surface element 10 is not bent back in the region of the upper end edge 16C and the lower end edge 16D.

In FIG. 4 it may be also identified that the support ribs 110 in each case have a chamfer 112. The chamfer 112 extends between the connected stiffening rib 11D inclined to the left and the open end 111 of the support rib 110. The chamfer 112 forms the edge of the support rib 110 remote from the surface element 10. As a result, material may be saved and thus the weight of the structural assembly 1 may be reduced.

Some (or alternatively all) stiffening elements 11A-11P comprise a widened base 113 in the region of their material connection with the surface element 10. In FIG. 4 it may be identified that the stiffening ribs 11D inclined to the left and the support ribs 110 in each case comprise such a widened base 113. By means of the widened bases 113 a particularly stable connection of the stiffening elements 11A-11P to the surface element 10 may be achieved.

FIG. 5 shows an enlarged detail of the view according to FIG. 4 in the region of the left-hand side edge 16A. In particular with reference to FIG. 5, it may be identified that the surface element 10 on its peripheral end edge 106 is provided with a stiffening element in the form of an end edge trim. 11J. The end edge trim 11J covers the end edge 106 and regions of the flange 105 adjoining the end edge 106. The end edge trim 11J is provided at the points where the end edge 106 of the surface element 10 is not already otherwise connected. The end edge trim 11J protects the end edge 106 from damage.

In the region of the end edge trim 11J the fiber material part of the surface element 10 is not fully consolidated (lofted). The individual fibers of the fiber material part, therefore, bear less closely against one another than in the fully consolidated regions. As a result, a particularly stable connection of the end edge trim 11J to the surface element 10 may be achieved.

FIG. 5 shows, moreover, that an the edge reinforcement 11E on the rear face of the structural assembly 1 a plurality of interface elements 11M, 11N are configured for connecting to a covering part. The interface elements 11M, 11N serve, in particular, for connecting to a flat flexible covering part, preferably a carpet.

As in particular FIGS. 1, 3 and 5 illustrate, on the outer edge of the edge reinforcement 11E an interface element is provided in the form of a weatherstrip duct 12M. The weatherstrip duct 12M is configured and designed for receiving the flat, flexible covering part. The weatherstrip duct 12M extends along the side edges 16A, 16B, the upper end edge 16C and/or the lower end edge 16D. Along the weatherstrip duct 12M a plurality of weatherstrip hooks 133 are arranged inside the weatherstrip duct 12M. The weatherstrip hooks 133 are configured for holding the flat, flexible covering part. For an improved flexibility of the weatherstrip hooks 133 these are partially cut free. The weatherstrip duct 12M is connected by a material connection to the surface element 10.

An adhesive duct 12N is arranged adjacent to the weatherstrip duct 12M. The adhesive duct 12N extends substantially parallel to the weatherstrip duct 12M. The adhesive duct 12N is configured and designed for receiving adhesive for an adhesive connection of the flat, flexible covering part to the structural assembly 1. By means of the adhesive duct, adhesive is able to be applied in a manner which is particularly optimized relative to consumption.

The weatherstrip duct 12M and/or the adhesive duct 12N may alternatively or additionally also serve as a cable duct for receiving a cable.

For attaching to the lock 3, the surface element 10 comprises a tab 108 which is bent back toward the front face of the surface element 10. By means of the tab 108 of the surface element 10 a stiffening element in the form of a stiffening frame 11M is connected by a material connection. The stiffening frame 11M frames edges of the tab 108 and at least partially covers the tab 108 on its side facing the lock 3. The stiffening frame 11M increases the stiffness of the tab 108 of the surface element 10. A plurality of horizontal stiffening ribs 11B abut the tab 108 and support said tab. To this end, two of the horizontal stiffening ribs 11B are raised toward the tab 108.

The structural assembly 1 is configured and designed to be deformed under load so that a bulge counteracting the deformation is formed. This may take place by a corresponding alignment of a plurality of fiber layers of the fiber material part of the surface element 10 and/or a corresponding arrangement of the stiffening elements 11A-11P. In this manner, in particular in the event of a front crash, a forward displacement of portions of the structural subassembly 1 may be reduced.

As already mentioned, the structural assembly comprises a plurality of interface elements 12A-12R.

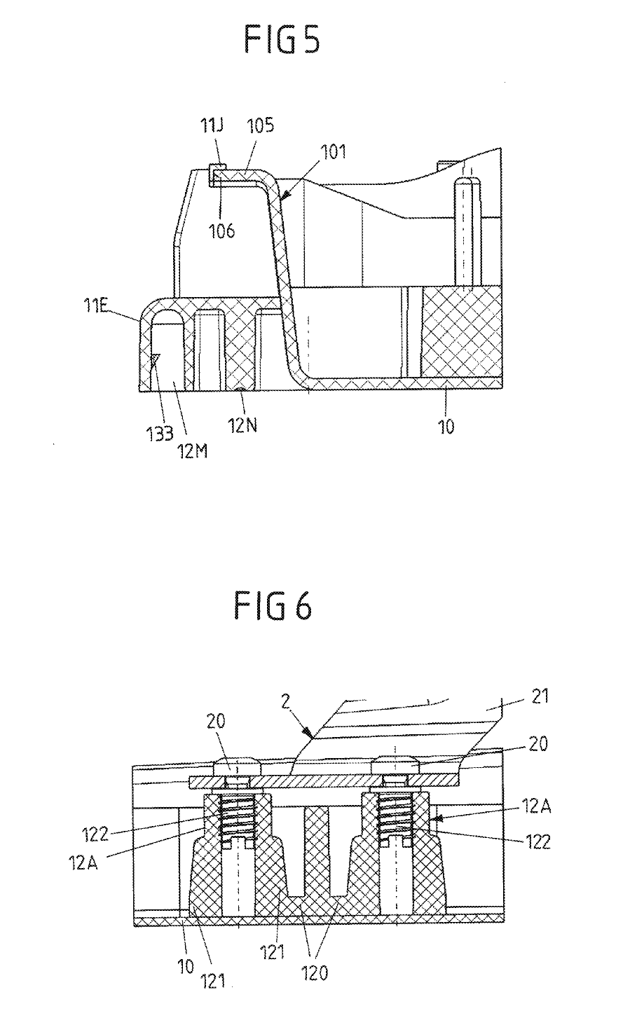

As in particular FIGS. 1, 2 and 6 illustrate, a plurality of interface elements in each case are formed as screw domes 12A for connecting to a central armrest. In the present case, the structural assembly 1 comprises four screw domes 12A for connecting to the central armrest.

The screw domes 12A are connected on the front face of the surface element 10 by a material connection thereto. The screw domes 12A are configured to be substantially hollow-cylindrical with a circular cross section. The screw domes 12A in each case comprise a widened base 120 for the stable material connection to the surface element 10. Moreover, the screw domes 12A comprise four respective support ribs 121 offset in each case by 90°, for additional stabilizing of the screw domes 12A. The screw domes 12A comprise in each case a threaded bushing 122 with an internal thread and an external thread. The threaded bushings 122 in each case are screwed by their external thread into the assigned screw dome 12A.

An armrest support 2 comprises two tabs 21 for the pivotable mounting of the central armrest, also not shown in the figures. By means of four screws 20 which in each case are screwed to the internal thread of the threaded bushing 122, the armrest support 2 is fastened to the structural assembly 1.

By cooperation with assigned locating holes in the armrest carrier 2, locating pins 12B permit prepositioning during the mounting of the armrest carrier 2 on the structural assembly 1. The locating pins 12B are connected by a material connection to the surface element 10 via the stiffening ribs 11A-11D.

In an alternative embodiment, the threaded bushings 122 are not screwed into the assigned screw domes 12A but designed as an insert part and connected by positive locking to the respective screw dome 12A. The connection by positive locking takes place by encapsulation by injection-molding around the threaded bushings 122, forming the screw domes 12A.

With reference in particular to FIGS. 1 to 3 and 7 to 9, therefore, a further interface element 12C of the structural assembly 1 is disclosed. This interface element is configured as a rotary joint bearing 12C and produces a connection of the structural assembly 1 with a transverse tube 4 of the vehicle seat backrest.

The rotary joint bearing 12C is arranged in the vicinity of the lower end edge 16D. It permits a pivoting of the structural assembly 1 relative to the remaining vehicle seat between the open and the closed state.

The rotary joint bearing 12C comprises a plurality (in the present case two) receivers 123 for mounting the transverse tube 4. The receivers 123 are in each case integrally connected to the edge reinforcement 11K in the region of the tapered region B1 and produced from the same material.

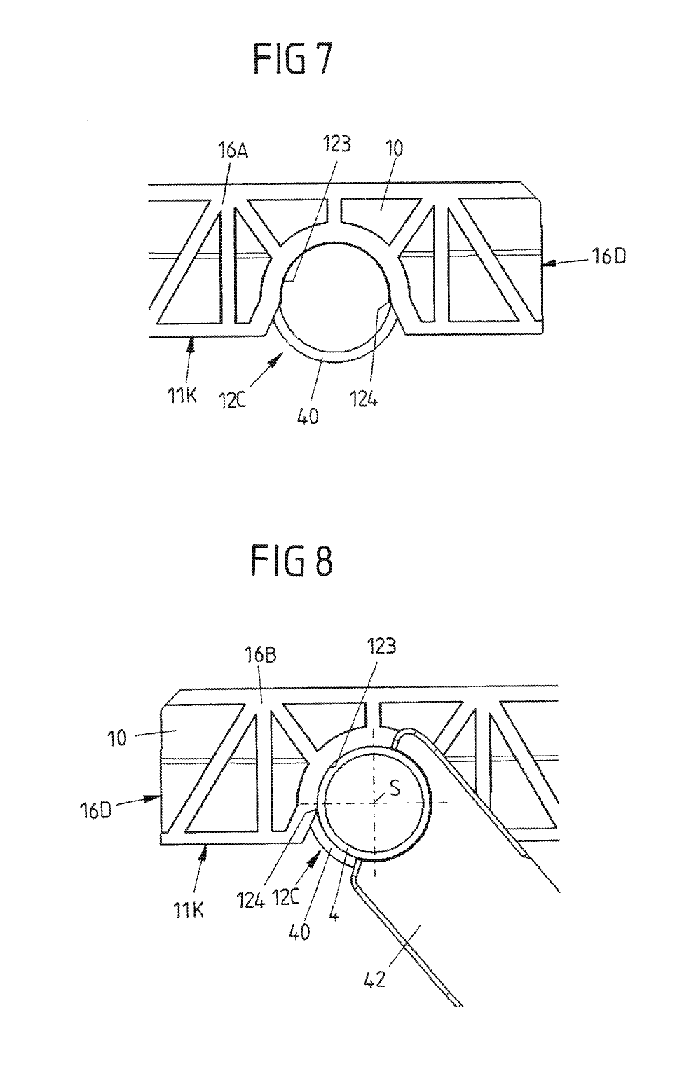

FIG. 7 shows a view of the left-hand side edge 16A of the structural assembly 1 in the region of the lower end edge 16D. The receiver 123 forms an undercut 124. FIG. 8 shows the receiver 123 on the right-hand side edge 1613 which also forms an undercut 124. If the transverse tube 4 is inserted into the receivers 123, assembly 1 is thus connected to the transverse tube 4 and may be secured thereto by two sheet metal clips 40.

Whilst FIG. 7 shows the receiver 123 and the sheet metal clips 40 but not the transverse tube 4, said transverse tube is shown mounted in the receivers 123 in FIG. 8. Two support arms 42 arranged on both sides of the structural assembly 1 are connected to the transverse tube 4. The support arms 42 are mounted on the vehicle seat for attaching the transverse tube 4 to the vehicle seat. The transverse tube 4 provides a pivot axis S, about which the structural assembly connected to the transverse tube 4 is pivotable.

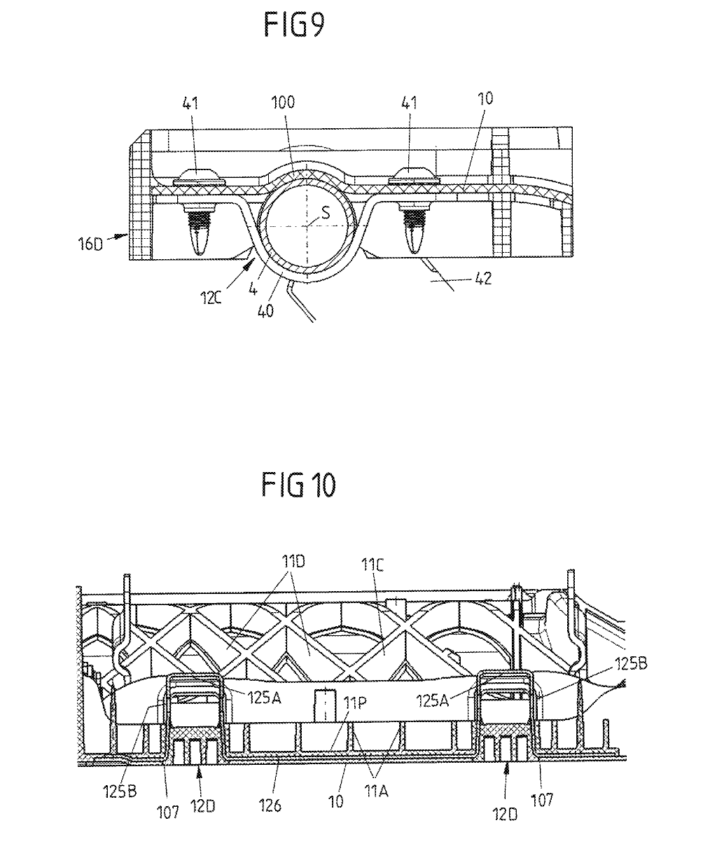

FIG. 9 shows a sectional view of the structural assembly 1 in the region of the transverse tube 4 connected thereto. One of the sheet metal clips 40 which surrounds the transverse tube 4 and is fastened by means of two screws 41 to the structural assembly 1 may be identified therein. The screws 41 in the present case are FDS screws which may connect the surface element 10 to the sheet metal clip 40 without pre-drilling.

Moreover, in particular in FIG. 9 it may be identified that the surface element 10 also forms a receiver 100. The receiver 100 of the surface element 10 is configured in the form of a groove-like recess which extends between the receivers 123 on the side edges 16A, 16B of the structural assembly 1. Together the receivers 123, 100 form the rotary joint bearing 120 on the side edges 16A, 16B of the structural assembly 1 and of the surface element 10. The receiver 100 of the surface element 10 may also be identified, in particular, in FIG. 1.

The structural assembly 1 further comprises a plurality of interface elements in the form of latching domes 12Q for connecting to at least one covering or frame (see in particular FIGS. 1 and 2). The latching domes 12Q comprise a widened base via which they are connected by a material connection to the surface element 10. The latching domes 12Q are configured to be substantially circular cylindrical. A cylinder axis of the latching domes 12Q is aligned substantially vertically relative to the adjacent portions of the surface element 10. In the present case, five latching domes 12Q are provided. Each of the latching domes 12Q is able to be connected in a latching manner to an assigned connecting mating piece. Alternatively the latching domes 12Q may also be configured as screw domes which may be brought into engagement with a screw.

FIG. 10 shows a sectional view of the structural assembly 1 in a region adjacent to the upper end edge 16C. The structural assembly 1 comprises two headrest holders 12D as is visible, in particular, from viewing FIGS. 1, 3 and 10 together. Each of the headrest holders 12D is configured and designed to receive and mount a headrest rod of a headrest.

Each of the headrest holders 12D comprises three receivers 125A-125C. The receivers 125A-125C are arranged spaced apart along a longitudinal axis of the structural assembly 1 extending parallel to the side edges 16A, 16B. The headrest rod may be inserted into the receivers 125A-125C. The receivers 125A-125C of each of the headrest holders 12D are aligned coaxially to one another.

A first receiver 125A of both headrest holders 12D is in this case configured by a common headrest bracket 126. The headrest bracket 126 is a material strip repeatedly bent back substantially at right angles (in particular a sheet metal strip). The headrest bracket 126 bears against the surface element. 10. It is configured as an insert part. The headrest bracket 126, with the exception of those regions which form the first receivers 125A, is fully enclosed by the surface element 10 and a stiffening surface 11P connected by a material connection to the surface element 10. The stiffening surface 11P forms a surface covering the headrest bracket 126, a plurality of (chamfered) vertical stiffening ribs 11A emerging from said surface. Thus the headrest bracket 126 is connected by positive locking to the surface element 10.

By a configuration of the headrest bracket 126 from metal, a particularly stable retention of the headrest may be achieved.

In the region of the first receivers 125A, in each case the surface element 10 is provided with a cutout 107, in each case a stiffening element in the form of a stiffening insert 11L being inserted therein. Each of the stiffening inserts 11L extends into the bent-back regions of the headrest bracket 126 which form the first receivers 125A. The stiffening inserts 11L, therefore, form a part of the first receivers 125A. On their side remote from the first receiver 125A, each of the stiffening inserts 11L comprises a plurality of vertical and horizontal stiffening ribs.

A second receiver 125B of both headrest holders 12D is formed by one of the horizontal stiffening ribs 11B.

The horizontal stiffening rib 11B is aligned parallel to the headrest bracket 126 and arranged spaced apart therefrom. In the region of the second receivers 125B the horizontal stiffening rib 11B is reinforced on one side and thus forms a through-opening. The horizontal stiffening rib 11B forming the second receivers 125B, is generally higher than the adjacent stiffening ribs 11A, 11B, 11D (viewed starting from the surface element. 10).

The first and second receivers 125A, 125B are substantially configured as square openings.

A third receiver 125C of both headrest holders 12D is formed by a further horizontal stiffening rib 11B. The third receivers 125C are configured in the form of recesses in that horizontal stiffening rib 11B.

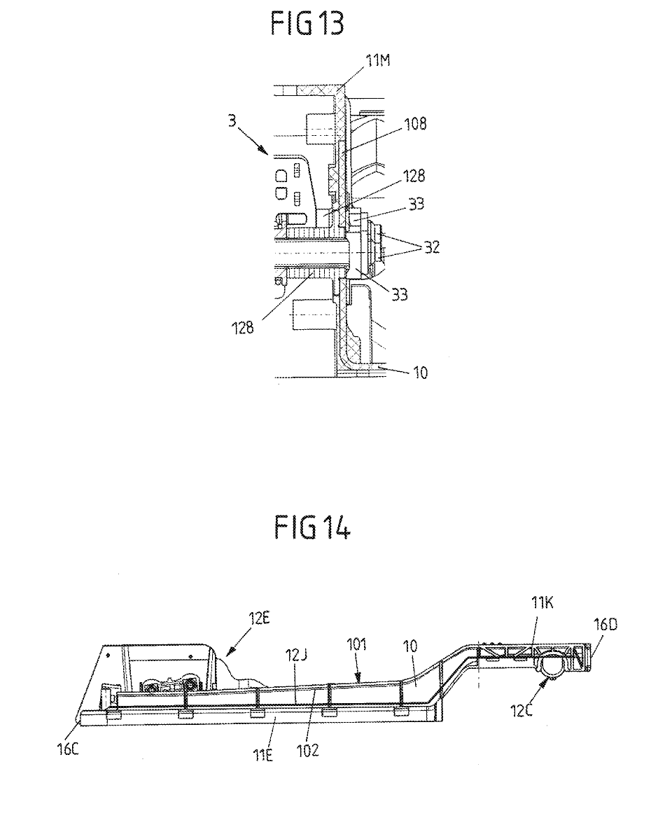

FIGS. 11 to 13 show different views of an attachment of a lock 3 to an interface element in the form of a lock holder 12E of the structural assembly 1. The lock 3 has a locked state and an unlocked state and is configured and designed in the locked state to be locked to an assigned locking element of the vehicle seat backrest. In the locked state of the lock 3 the structural assembly 1 is not pivotable about the pivot axis S relative to the vehicle seat backrest.

For effecting the locking, the lock 3 comprises a lock mechanism 30 which in the locked state of the lock 3 cooperates in a locking manner with the assigned locking element. The lock. 3 also comprises a pushbutton 31. The pushbutton 31 is operatively connected to the lock mechanism 30. By an actuation of the pushbutton 31, the lock 3 is transferred from the locked state into the unlocked state.

The lock holder 12E is arranged on the bent-back tab 108 of the surface element 10. The tab 108 protrudes substantially vertically from adjacent planar portions of the surface element 10. A region of the surface element 10 between the start of the tab 108 on the surface element 10 and the next adjacent vertical stiffening rib 11A is set back relative to adjacent planar portions of the surface element 10 (in the form of a step).

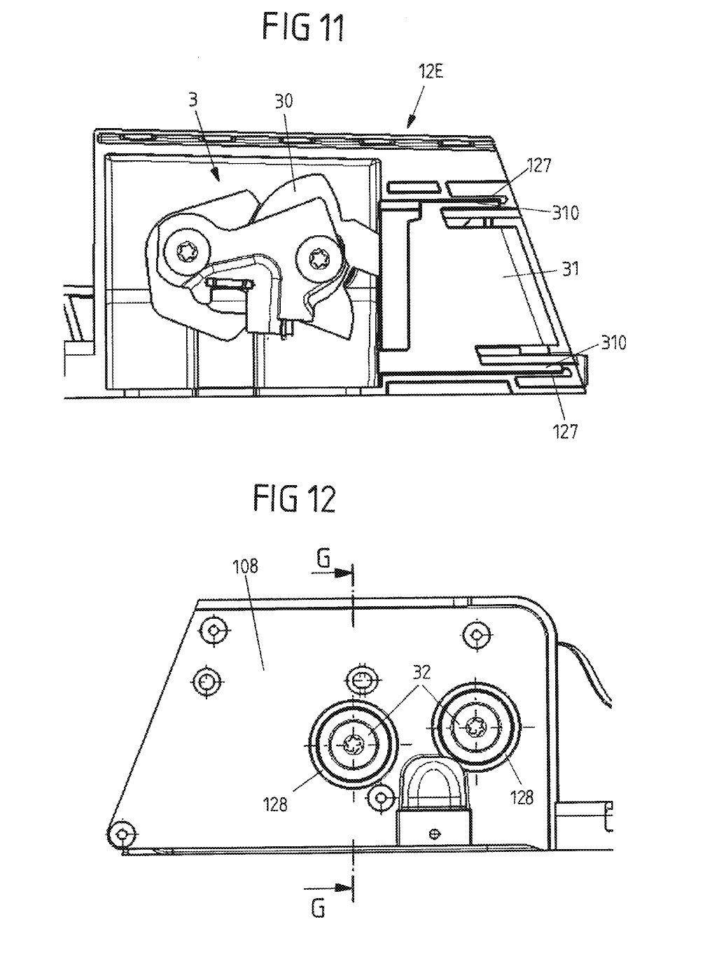

Two openings are provided in the tab 108, in each case a metal insert 128 being inserted therein. Each of the two metal inserts 128 of the lock holder 12E is penetrated by a screw 32 of the lock 3. The screws 32 for holding the lock 3 on the structural assembly 1 are in each case in engagement with an assigned thread of the lock 3. In each case a securing nut 33 penetrated by the screw 32 is provided on the side of the tab 108 of the surface element 10 opposing the lock 3, said securing nut securing the respective metal insert 128 to the tab 108. FIG. 12 shows the side of the tab 108 of the surface element 10 remote from the lock 3 without the securing nuts 33.

The metal insert 128 has a circular cylindrical shaft and a peripheral flange on the outer surface of the shaft. The flange is positioned on the tab 108 of the surface element 10 (i.e. on the organosheet) and is supported thereon. The flange is set back relative to a front face of the shaft approximately by the thickness of the tab 108. The front face of the shaft of the metal insert 128 thus terminates flush with a surface of the tab 108 opposing the flange of the metal insert 128. The flange of the metal insert 128 supports the metal insert 128 against tilting relative to the tab 108. The lock mechanism 30 (or a part of the lock mechanism 30) is rotatably mounted on the metal insert 128.

The lock holder 12E also forms (in the present case two) guide tracks 127 which are configured and designed to guide assigned guide pins 310 of the pushbutton 31. The guide tracks 127 permit a displacement of the pushbutton 31 with the actuation thereof.

The structural assembly 1 comprises a plurality of interface elements for guiding and holding cables, in the form of cable clips 12F, cable holders 12G and cable guides 12H, 12J. Cables serve, for example, for supplying the power and/or activating the headrest, the lock 3 and/or further components which are connected or able to be connected to the structural assembly 1.

FIG. 1 shows a plurality of cable clips 12F with two respective clip portions which are configured to receive and to hold a cable by non-positive locking between the clip portions. The cable clips are configured on upper edges of a plurality of stiffening ribs 11A, 11D remote from the surface element.

A cable holder 12G comprises three pins protruding vertically from the surface element 10 or a stiffening rib 11A, 11B. The pins are substantially arranged and. configured in a row, in order to hold a cable by non-positive locking (in a spring-elastic manner) guided alternately by the pins. The cable holders 12G form a chicane for the cable.

A first cable guide 12H is arranged in the region of a lower corner between the left-hand side edge 16A and the lower end edge 16D. The first cable guide 12H is configured to receive a cable and to guide it from the rear face of the structural assembly 1 onto the front face of the structural assembly 1.

FIG. 14 shows a path of a second cable guide 12J along the left-hand side edge 16A of the structural assembly 1. The second cable guide 12J extends along the edge 101 of the surface element 10 adjacent to the inner edge 102. The second cable guide 12J is arranged below a Z-lay of the edge 101. By this arrangement the cable is particularly well protected by the flange 105 of the surface element 10 and the edge reinforcements 11E, 11K.

Moreover, it may be identified in FIG. 14 that the surface element 10 has an S-lay (or Z-lay depending on the viewing direction) and/or an S-shaped or Z-shaped cross-sectional profile. The tapered region B1 shown to the right in FIG. 14 is set back relative to the non-tapered region B2 shown to the left (in a stepped manner). The S-lay of the surface element 10 is able to absorb energy when the structural assembly 1 is loaded.

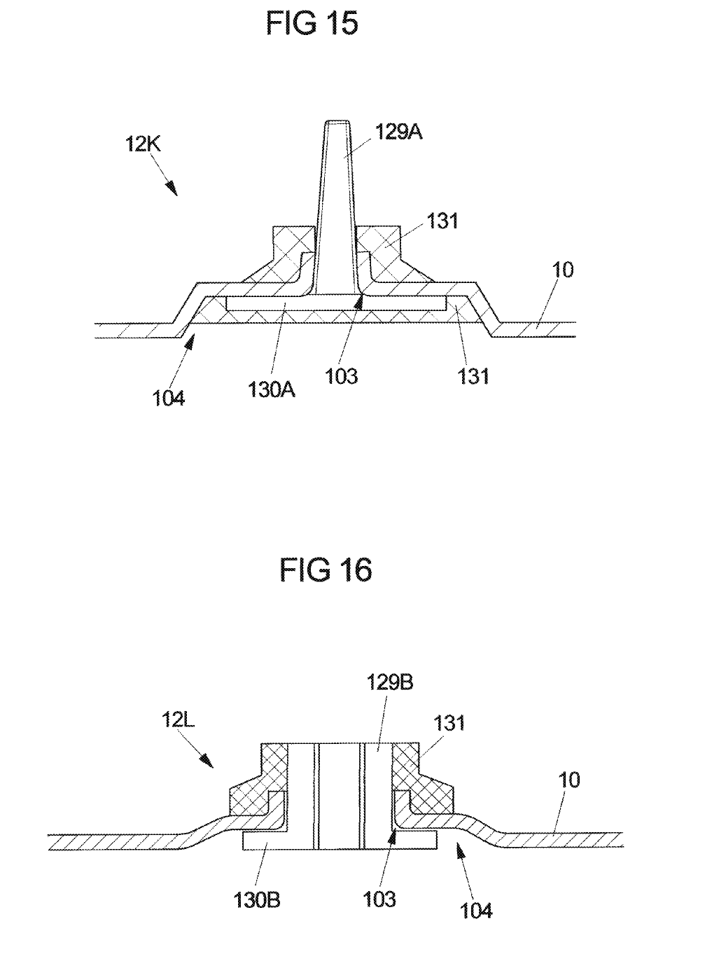

FIGS. 15 and 16 show two variants of interface elements in the form of screw connections 12K, 12L for use on a structural assembly, in the manner of the structural assembly 1 according to FIGS. 1 to 14, for example for connecting the structural assembly 1 to a central armrest.

The screw connections 12K, 12L in each case comprise a screw insert 129A, 129B with a widened foot 130A, 130B. The screw insert 129A, 129B in each case penetrates an opening 103 in the surface element 10. At the opening 103 the surface element 10 is bent up forming a duct. The opening 103 in the surface element 10 is configured on a recess 104, the foot 130A, 130B of the respective screw insert 129A, 129B being received therein. The recess 104 forms together with the opening 103 a conical through-passage.

The widened foot 130A, 130B of the respective screw insert 129A, 129B has a larger diameter than the opening 103 in the surface element 10. A thread of each of the screw inserts 129A, 129B which is able to be brought into engagement with an assigned mating piece is arranged on the side of the surface element 10 opposing the foot 130A, 130B. In this manner the screw inserts 129A, 129B are particularly well secured to the surface element 10. Due to the recess 104 the foot 130A, 130B does not protrude from the surface element 10.

Whilst the screw insert 129A according to FIG. 15 is configured as a threaded bolt with an external thread, the screw insert 129B according to FIG. 16 is configured as a threaded bushing with an internal thread.

On the side of the surface element 10 opposing the foot 130A, 130B, both variants of the screw insert 129A, 129B are encapsulated by injection-molding material 131 on an outer portion adjoining the surface element 10. The injection-molding material 131 is connected by a material connection to the surface element 10. The foot 130A of the screw insert 129A according to FIG. 15 is over-molded with injection-molding material 131. The recess 104 is partially filled with injection-molding material 131 (alternatively the recess 104 is entirely filled with injection-molding material 131). In a variant not shown, the foot 130B of the screw insert 129B according to FIG. 16 is also over-molded with injection-molding material 131.

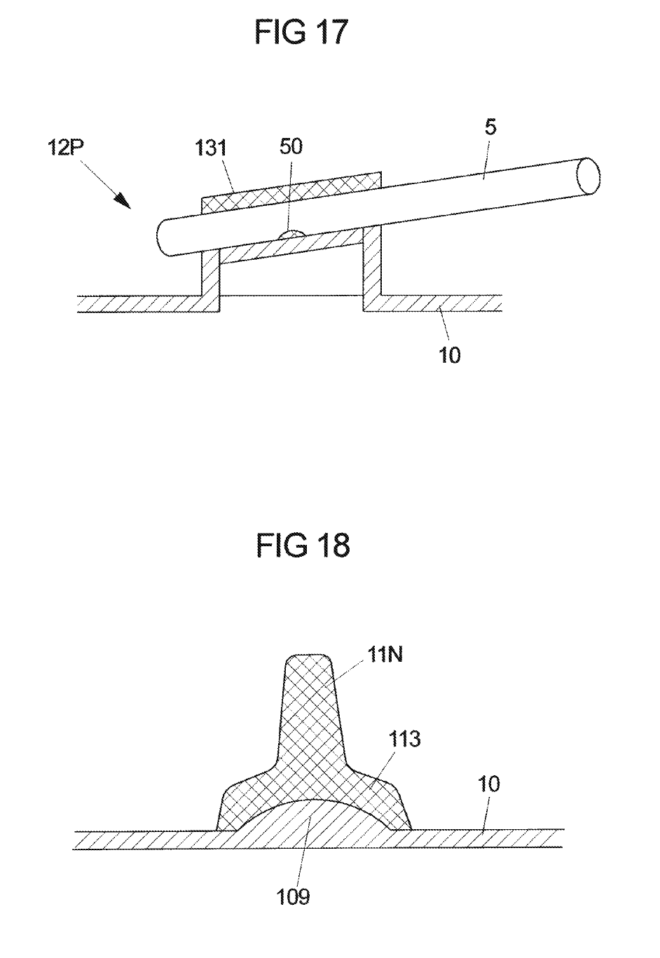

FIG. 17 shows an interface element in the form of a holder 12P for use on a structural assembly, in the manner of the structural assembly 1 according to FIGS. 1 to 14. In the present case, by way of example, the holder 12P is connected to a rod 5. The rod 5 is, for example, a headrest rod of a headrest. The rod 5 comprises a recess 50. The surface element. 10 is pressed into the recess 50. This takes place, for example, by means of a corresponding mandrel. In the region of the recess 50 the rod 5 is positioned on a raised chamfered region of the surface element 10 and is surrounded by the injection-molding material 131 which has been injection-molded thereon. By pressing the surface element 10 into the recess 50, a particularly stable connection of the rod 5 with the structural assembly 1 is produced, similar to a clinch connection.

Alternatively, the rod comprises a plurality of recesses and/or one or more holes into which the surface element 10 is pressed. The pressing of the surface element 10 into a recess or a hole may be provided when connecting to any insert part or other component, in particular the headrest bracket 126 of the structural assembly 1 of FIGS. 1 to 14.

FIG. 18 shows a cross section of a stiffening element in the form of a stiffening rib 11N. The stiffening rib 11N is connected to the surface element 10 which is produced from organosheet and protrudes substantially vertically therefrom. In the region of its connection to the surface element 10 the stiffening rib 11N has a widened base 113. By means of the widened base 113 the contact surface on which the stiffening rib 11N is connected to the surface element 10 is enlarged.

relative to a stiffening rib without a widened base. By means of the enlarged contact surface, the connection is particularly stable. In cross section the stiffening rib 11N has the shape of a T.

Below the contact surface between the stiffening rib 11N and the surface element 10, the fiber material part of the surface element 10 is not fully consolidated. The fibers of the fiber material part are arranged below the contact surface at a greater distance from one another than in adjacent regions. By the incomplete consolidation of the fiber material part on the contact surface, the material connection of the stiffening rib 11N to the surface element 10 is particularly stable.

The fiber material part is embedded in a thermoplastic matrix. The stiffening rib is produced from the same material as the plastics matrix.

The connection of any stiffening element 11A-11P and/or interface element 12A-12R described herein with the surface element 10 may be implemented according to the connection shown in FIG. 18 with a widened base and/or on a not fully consolidated region of the surface element 10.

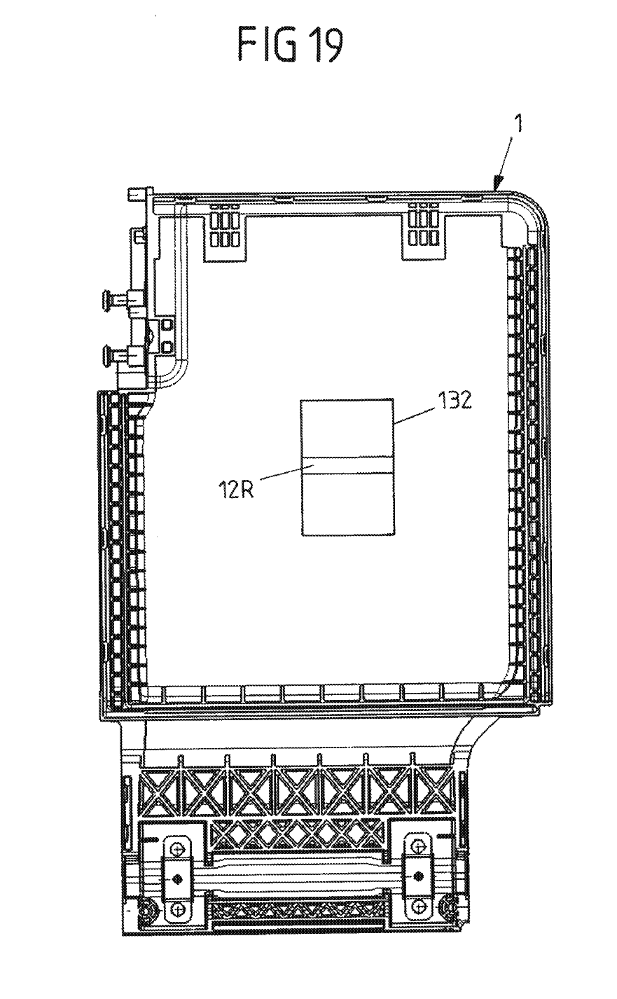

FIG. 19 shows the structural assembly 1 according to FIGS. 1 to 14 with an additional interface element in the form of top tether strap 12R. The top tether strap 12R is configured by a pre-cut part 132 made of organosheet. The top tether strap 12R is configured and designed to be connected to a seat belt and to mount said seat belt. The pre-cut part 132 is connected to the surface element 10 by a material connection, for example by means of injection-molding and/or by contacting and heating the surface element 10 and the pre-cut part 132.

In the case of a vehicle crash, in particular a front crash, large forces may act on a seat belt connected to the top tether strap 12R. In this case there is the risk that the seat belt slips to the side, whereby a risk of injury of a vehicle occupant may be increased. In order to prevent such a slipping, the structural assembly 1 is (optionally) provided with set rupture points. The set rupture points are configured in the form of set rupture lines 14. The set rupture lines 14 extend in parallel and at a distance from one another and adjoin the upper end edge 16C. Relative to the upper end edge 16C the set rupture lines 14 run substantially vertically. The set rupture lines are, for example, configured in the form of ribs or notches and/or material weakenings. In the present case the set rupture lines 14 are configured by weakenings in the form of notches in the stiffening surface 11P which has been injection-molded onto the surface element 10. Alternatively or additionally, the surface element 10 may also be provided with weakenings. The weakenings are configured and designed to cause a material failure at a predetermined point when an acting force exceeds a predetermined maximum force (for example in a so-called ADR pull test).

If the set rupture lines 14 rupture, a recess is formed on the upper end edge 16C into which the seat belt engages and by which it is prevented from slipping to the side. The seat belt is thus captured.

The structural assembly 1 described with reference to FIGS. 1 to 19 is thus designed as an organosheet plastics hybrid component and therefore meets high requirements for stability with a particularly low weight. By the integration of a plurality of stiffening elements and interface elements in the structural assembly 1 the production is additionally particularly simple. Thus the number of connection processes required may be markedly reduced.

The surface element. 10 is produced from organosheet and thus from a thermoformable composite material. For producing the surface element 10 the organosheet is provided in flat form and thus is provided as a two-dimensional material. In order to produce the surface element a corresponding piece is cut out or stamped out from the surface of the organosheet. Alternatively, a corresponding piece of organosheet is already produced in this shape and no longer has to be cut to size.

In a subsequent step, the pre-cut part from which the surface element 10 is intended to be produced is shaped. Since the organosheet is a thermoformable material, this may take place in a simple manner by means of thermoforming, i.e. by heating the pre-cut part with subsequent mechanical deformation.

The stiffening elements 11A-11P and the interface elements 12A-12Q (with the exception of the top tether strap 12R) in the present case are not produced from organosheet. Instead, they consist of a plastics material and are injection-molded by means of plastic injection-molding onto the surface element 10. The stiffening elements 11A-11P and the interface elements 12A-12Q are in this manner connected by a material connection to the surface element 10. In order to simplify as far as possible the production of the structural assembly 1, the shaping of the surface element 10 may be carried out in the same tool as the injection-molding.

Depending on which thermoplastic material the matrix embedding the fiber material part consists of, it may be advantageous to use the same plastics material in the injection-molding in order to form the stiffening elements 11A-11P and the interface elements 12A-12Q.

During the injection-molding, the injection-molding material configuring the stiffening ribs 11D and the support ribs 110 protruding therefrom is injected into the injection-molding tool at different points. At the same time the injection-molding material flows from the portion of the injection-molding tool forming the support rib 110 (depending on the arrangement of the injection-molding points) into the portion forming the stiffening rib 11D or vice versa. Since the support ribs 110 are configured with open ends 111, no two flow fronts of injection-molded material come into contact with one another. In contrast, during the production of the intersection points of stiffening ribs 11A-11D, 11F-11H, 11N, a plurality of such fronts come into contact with one another. The fronts in this case form a material connection. In the region of this connection, however, the corresponding stiffening rib 11A-11D, 11F-11H, 11N optionally has less load-bearing capacity than in the regions which are formed by a single flow of injection-molding material (in particular the connection may tear under tensile load). The stiffening ribs 11D provided with support ribs 110, therefore, have a particularly high degree of stability relative to tensile load.

During the injection-molding, insert parts (such as the headrest bracket 126) are encapsulated by injection-molding by means of insert technology, producing a positive-locking connection with the surface element 10.

An incomplete consolidation of a region (for example in the region of the end edge 106) of the surface element may be effected by the injection-molding (or generally by heating). The surface element 10 is then not fully compressed in the region in order to obtain the incomplete consolidation.

### LIST OF REFERENCE NUMERALS

1 Structural assembly

10 Surface element

100 Receiver

101 Edge

102 Inner edge

103 Opening

104 Recess

105 Flange

106 End edge

107 Cutout

108 Tab

109 Not fully consolidated region

11A Vertical stiffening rib

11B Horizontal stiffening rib

11C Stiffening rib inclined to the right

11D Stiffening rib inclined to the left

11E Edge reinforcement

11F Longitudinal rib

110 Connecting rib

11H Stiffening rib

11J End edge trim

11K Edge reinforcement (tapered region)

11L Stiffening insert

11M Stiffening frame

11N Stiffening rib

11P Stiffening surface

110 Support rib

111 Open end

112 Chamfer

113 Base

12A Screw dome

12B Locating pin

12C Rotary joint bearing

12D Headrest holder

12E Lock holder

12F Cable clip

12G Cable holder

12H First cable guide

12J Second cable guide

12K Screw connection.

12L Screw connection

12M Weatherstrip duct

12N Adhesive duct

12P Holder

12Q Latching dome

12R Top tether strap

120 Base

121 Support rib

122 Threaded bushing

123 Receiver

124 Undercut

125A First receiver

125B Second receiver

125C Third receiver

126 Headrest bracket

127 Guide track

128 Metal insert

129A Screw insert (threaded bolt)

129B Screw insert (threaded bolt)

130A, 130B Foot

131 injection-molding material

132 Pre-cut part

133 Weatherstrip hook

14 Set rupture line

16A, 16B Side edge

16C Upper end edge

16D Lower end edge

2 Armrest support

20 Screw

21 Tab

3 Lock

30 Lock mechanism

31 Pushbutton

310 Guide pin

32 Screw

33 Securing nut

4 Transverse tube

40 Sheet metal clip

41 Screw

42 Support arm

5 Rod

50 Recess

A Cutout

B1 Tapered region

B2 Non-tapered region

B3 Intersection region

B4 Parallel region

B5 Transition region

K Intersection point

S Pivot axis

1-33. (canceled)

34. A structural assembly for a vehicle seat backrest, with
a surface element which is configured and designed to form at least one part of a rear wall of the vehicle seat backrest and/or to close a recess for a load through-opening in the vehicle seat backrest, and
at least one interface element which is configured and designed for connecting to a further component of the vehicle seat backrest,
wherein the surface element is produced from a thermoformable composite material and is connected by a material connection to at least one part of the interface element, wherein the at least one interface element is configured as a duct, which is configured at least one of
as a weatherstrip duct and comprises at least one weatherstrip hook for securing a covering as a further component,
as an adhesive duct for receiving adhesive, wherein a further component is able to be bonded by means of the adhesive received in the adhesive duct, and
as a cable duct for receiving a cable.

35. The structural assembly as claimed in claim 34, wherein the composite material is configured as a composite consisting of a thermoplastic matrix and a fiber material part embedded therein, in particular as an organosheet.

36. The structural assembly as claimed in claim 35, wherein the fiber material part of the surface element is configured as a woven fabric, a layered fabric, as a balanced woven fabric and/or sheared woven fabric.

37. The structural assembly as claimed in claim 35, wherein the fiber material part of the surface element is not fully consolidated in a region of the material connection to the interface element.

38. The structural assembly as claimed in claim 35, wherein the fiber material part has at least one cutout.

39. The structural assembly as claimed in claim 34, wherein the interface element is produced from a different material from the surface element, in particular is produced from the same material as a thermoplastic matrix of the composite material of the surface element.

40. The structural assembly as claimed in claim 34, wherein the surface element is configured to be trough-shaped and/or forms a receiver which provides at least one part of a rotary joint bearing for attaching the structural assembly to the vehicle seat backrest.

41. The structural assembly as claimed in claim 34, wherein the surface element and/or the interface element comprises at least one set rupture point.

42. The structural assembly as claimed in claim 34, wherein the at least one interface element is arranged in the region of an edge of the surface element which has a C-shaped or Z-shaped cross section.

43. The structural assembly as claimed in claim 34, wherein at least one further interface element is provided and configured as a screw dome, the further component being able to be screwed thereto and/or at least one further interface element is provided and is configured as a rotary joint bearing for the pivotable attachment of the structural assembly to the vehicle seat backrest or for the pivotable attachment of an armrest.

44. The structural assembly as claimed in claim 34, wherein at least one further interface element comprises an insert part which is connected by positive locking to the surface element and is produced, in particular, from a metal.

45. The structural assembly as claimed in claim 44, wherein the insert part comprises at least one opening and/or recess, a partial region of the surface element being pressed therein.

46. The structural assembly as claimed in claim 44, wherein at least one further interface element is configured and designed for connecting to a headrest, and in that the insert part is a headrest bracket which is configured and designed to receive and support a headrest rod of the headrest.

47. The structural assembly as claimed in claim 44, wherein the insert part is configured as a threaded insert which, in particular, is arranged inside an opening in the surface element and to which the further component is able to be screwed.

48. The structural assembly as claimed in claim 34, wherein at least one further interface element is configured and designed for connecting to an actuating element which is able to be actuated for locking and/or unlocking a lock, wherein the interface element comprises at least one guide track which is designed and configured to guide the actuating element during an actuation.

49. The structural assembly as claimed in claim 34, wherein at least one further interface element is configured as a top tether strap.

50. The structural assembly as claimed in claim 34, wherein at least one further interface element has a resilient spring element which is configured and designed to cushion an adjacent further component of the vehicle seat backrest during a relative movement between the structural component and the adjacent further component of the vehicle seat backrest.

51. The structural assembly as claimed in claim 34, wherein at least one stiffening element which is configured and designed for increasing the stiffness of the surface element is provided.

52. A structural assembly for a vehicle seat backrest having
a surface element which is configured and designed to form at least one part of a rear wall of the vehicle seat backrest and/or to close a recess for a load through-opening in the vehicle seat backrest, and
at least one stiffening element which is configured and designed to increase the stiffness of the surface element and/or at least one interface element which is configured and designed for connecting to a further component of the vehicle seat backrest,
wherein the surface element is produced from a thermoformable composite material and is connected by a material connection to at least one part of the stiffening element and/or the interface element, wherein the at least one interface element is configured and designed for connecting to an actuating element which is able to be actuated for locking and/or unlocking a lock, wherein the interface element comprises at least one guide track which is designed and configured to guide the actuating element during an actuation.

53. A method for producing a structural assembly for a vehicle seat backrest, comprising the following steps:
providing a surface element which is configured and designed to form at least one part of a rear wall of the vehicle seat backrest and/or to close a recess for a load through-opening in the vehicle seat backrest, and
to provide at least one interface element which is configured and designed for connecting to a further component of the structural assembly, wherein
the surface element is produced from a thermoformable composite material,
the surface element is connected by a material connection to at least one part of the interface element, and
the at least one interface element is configured as a duct, which is configured at least one of
as a weatherstrip duct and comprises at least one weatherstrip hook for securing a covering as a further component,
as an adhesive duct for receiving adhesive, wherein a further component is able to be bonded by means of the adhesive received in the adhesive duct, and
as a cable duct for receiving a cable.
